(19) United States
(12) Patent Application Publication
(10) Pub. No.: US 2025/0355385 A1
(43) Pub. Date: Nov. 20, 2025

(54) IMAGE FORMING APPARATUS AND METHOD

(71) Applicant: TOSHIBA TEC KABUSHIKI KAISHA, Tokyo (JP)

(72) Inventor: Masaya Tanaka, Sunto Shizuoka (JP)

(21) Appl. No.: 19/068,029

(22) Filed: Mar. 3, 2025

(30) Foreign Application Priority Data
May 17, 2024 (JP) 2024-081240

(51) Int. Cl. G03G 15/20; G03G 15/00

(52) U.S. Cl. CPC G03G 15/2039; G03G 15/2064; G03G 15/6588

(57) ABSTRACT

According to one embodiment, an image forming apparatus includes a fixing unit and a fixing control unit. The fixing unit is configured to pressurize a sheet to fix an image onto the sheet. The fixing control unit performs, on the fixing unit, a first control for pressurizing a first sheet not including a wireless tag with a first load and a second control for pressurizing a second sheet including the wireless tag with a second load lower than the first load.

### CROSS-REFERENCE TO RELATED APPLICATION

This application is based upon and claims the benefit of priority from Japanese Patent Application No. 2024-081240, filed on May 17, 2024, the entire contents of which are incorporated herein by reference.

### FIELD

Embodiments described herein relate generally to an image forming apparatus and method.

### BACKGROUND

In the related art, an image forming apparatus such as a printer and a multifunction peripheral may use a sheet provided with a wireless tag. Various types of information are written to the wireless tag. For example, information is written to the wireless tag on a conveyance path along which the sheet is conveyed.

The image forming apparatus includes a fixing unit configured to heat a toner on the sheet. The fixing unit includes, for example, a heating unit and a pressurizing unit. The pressurizing unit forms a nip region. When the sheet passes through the nip region, the toner on the sheet is heated and fixed. Here, when the sheet provided with the wireless tag passes through the fixing unit, there is a risk that the wireless tag may be damaged by pressure in the nip region.

### DESCRIPTION OF THE DRAWINGS

FIG. 1 is an external view illustrating an example of an overall configuration of an image forming apparatus according to an embodiment;

FIG. 2 is a view illustrating an example of an internal configuration of the image forming apparatus;

FIG. 3 is a block diagram illustrating an example of a functional configuration of the image forming apparatus;

FIG. 4 is a flowchart illustrating an example of a fixing control process;

FIG. 5 is a flowchart illustrating an example of a fixing control process performed by an image forming apparatus according to a first modification; and

FIG. 6 is a flowchart illustrating an example of a fixing control process performed by an image forming apparatus according to a third modification.

### DETAILED DESCRIPTION

An embodiment provides an image forming apparatus and method capable of preventing damage to a wireless tag.

In general, according to one embodiment, an image forming apparatus includes a fixing unit and a fixing control unit. The fixing unit is configured to pressurize a sheet to fix an image onto the sheet. The fixing control unit is configured to perform, on the fixing unit, a first control for pressurizing a first sheet not including a wireless tag with a first load and a second control for pressurizing a second sheet including the wireless tag with a second load lower than the first load.

An image forming apparatus and method according to an embodiment will be described below with reference to the drawings. In the following description, components having the same or similar functions are denoted by the same reference numerals. Duplicated components may not be described.

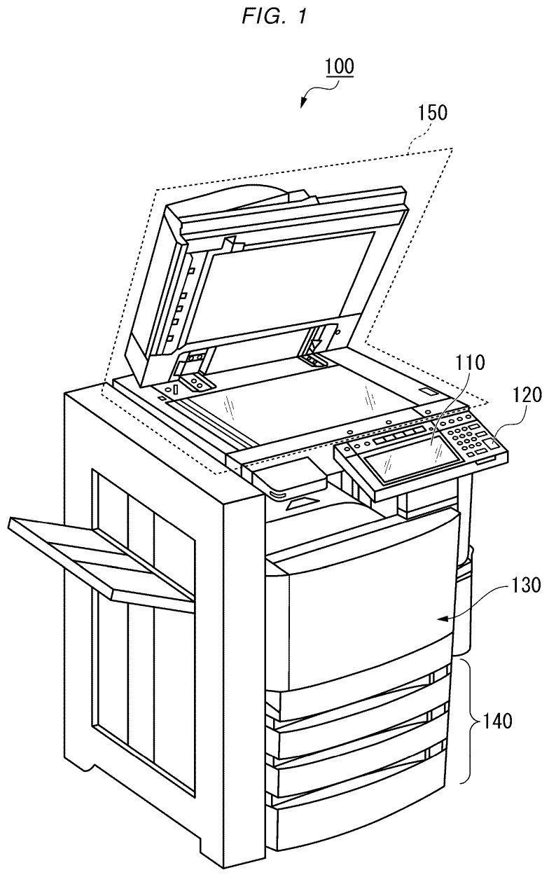

First, an overall configuration of an image forming apparatus 100 will be described with reference to FIG. 1.

FIG. 1 is an external view illustrating an example of the overall configuration of the image forming apparatus 100 according to the embodiment. The image forming apparatus 100 is, for example, a multifunction peripheral (MFP). The image forming apparatus 100 is disposed in a workplace such as an office. As illustrated in FIG. 1, the image forming apparatus 100 includes a display 110, a control panel 120, a printer 130, a sheet containing unit 140, and an image reading unit 150.

The display 110 is, for example, a liquid crystal display with a touch panel. The display 110 displays various types of information. The display 110 receives various input operations from an operator such as selection of a sheet type. The display 110 outputs operation signals in response to the various input operations received from the operator.

The control panel 120 includes various operation keys such as a numeric keypad and a start key. The control panel 120 receives various input operations from the operator such as selection of a sheet type. The control panel 120 outputs operation signals in response to the various input operations received from the operator.

The printer 130 performs a series of printing operations using various types of information output from the display 110, the control panel 120, the image reading unit 150, and the like. The series of printing operations include an operation of inputting image information, an operation of forming an image, an operation of transferring the formed image to a sheet, and an operation of conveying the sheet, for example.

The sheet containing unit 140 includes a plurality of sheet cassettes. Each of the sheet cassettes contains sheets according to sheet types. The sheet types include sheet sizes and sheet kinds. For example, the sheet sizes are an A5 size, an A4 size, and an A3 size. The sheet kinds include normal copy paper, a sheet with a wireless tag, and the like. The wireless tag is, for example, a radio frequency identifier (RFID) tag. The sheet kinds include a photographic sheet, a label sheet, a polyester film sheet, and the like.

In the present embodiment, the plurality of sheet cassettes include a sheet cassette in which normal copy paper is contained and a sheet cassette in which a sheet with a wireless tag is contained. The image forming apparatus 100 stores information indicating the sheet cassette in association with information indicating the type of sheet contained therein. Such association can be set by an operation of an operator such as a user or an inspection staff. When the image forming apparatus 100 acquires information indicating the type of sheet to be printed, the image forming apparatus 100 can specify the type of sheet and specify the sheet cassette in which the specified sheet is contained.

The image reading unit 150 includes an automatic document feeder and a scanner. The automatic document feeder feeds a document placed on a document tray to the scanner. The scanner optically reads the document fed by the automatic document feeder or a document placed on a document glass table. Then, the scanner forms an image of reflected light from the document on a light receiving surface of a charge coupled device (CCD) sensor. Thereby, the scanner can read the document image. The image reading unit 150 generates image information (image data) using a reading result from the scanner.

In the following description, a sheet with a wireless tag will be referred to as a “wireless tag sheet”, and other sheets (sheets without a wireless tag) will be referred to as “normal sheets”. The wireless tag sheet and the normal sheet will simply be referred to as a “sheet” when there is no particular distinction therebetween.

### Internal Configuration of Image Forming Apparatus 100

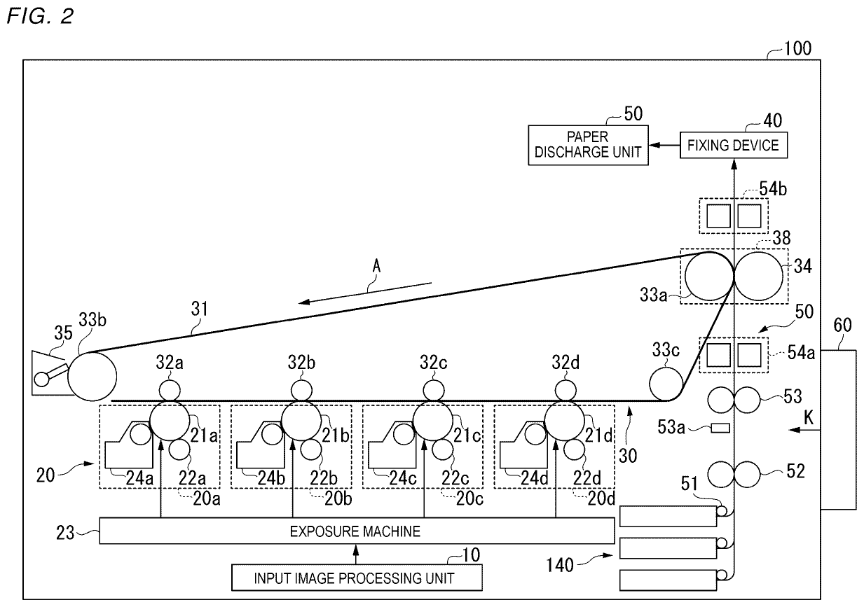

FIG. 2 is a diagram illustrating an example of an internal configuration of the image forming apparatus 100. As illustrated in FIG. 2, the image forming apparatus 100 (printer 130) is a so-called quadruple tandem type image forming apparatus. The image forming apparatus 100 includes an input image processing unit 10, image forming units 20 (20a to 20d), an intermediate transfer unit 30, a fixing device 40, a sheet conveying unit 50, and a wireless tag communication device 60. In the following description, reference characters a to d in the drawings may be omitted as appropriate.

### Input Image Processing Unit 10

The input image processing unit 10 inputs image information. The image information to be input is image information generated by the image reading unit 150 or image information transmitted from another device such as a personal computer. The input image processing unit 10 performs digital image processing of processing the input image information according to an initial setting or the operator's setting. For example, the digital image processing includes grayscale correction based on grayscale correction data. In addition to grayscale correction, the digital image processing may include processing for image data such as various correction processing such as color correction and shading correction, and compression processing.

### Image Forming Unit 20

Next, the image forming units 20 (image forming units 20a to 20d) will be described. The four image forming units 20a to 20d are arranged in parallel. Each of the image forming units 20a to 20d corresponds to a color, respectively. Specifically, the image forming unit 20a corresponds to yellow (Y). The image forming unit 20b corresponds to magenta (M). The image forming unit 20c corresponds to cyan (C). The image forming unit 20d corresponds to black (K).

Each of the image forming units 20 (20a to 20d) includes photoconductor drums 21 (21a to 21d), chargers 22 (22a to 22d), a shared exposure machine 23, developing machines 24 (24a to 24d), and a drum cleaning device (not illustrated), respectively.

The photoconductor drum 21 is, for example, a charging-type organic photo-conductor (OPC). Specifically, the photoconductor drum 21 is a charging-type organic photo-conductor in which an undercoat layer, a charge generation layer, and a charge transport layer are stacked in this order on a peripheral surface of a conductive cylinder made of aluminum. The photoconductor drum 21 has photoconductivity.

The charger 22 generates corona discharge. The charger 22 uniformly charges the surface of the photoconductor drum 21.

The exposure machine 23 is, for example, a semiconductor laser. The exposure machine 23 irradiates the photoconductor drum 21 with laser light corresponding to an image of a color component. When the surface of the photoconductor drum 21 is irradiated with the laser light from the exposure machine 23, a potential of a region irradiated with the laser light on the surface of the photoconductor drum 21 changes. Due to such change in potential (potential difference), an electrostatic latent image is formed on the surface of the photoconductor drum 21.

The developing machine 24 contains a developer. The developing machine 24 allows a toner of a color component to adhere to the surface of the photoconductor drum 21. Thus, a toner image is formed on the photoconductor drum 21. In other words, the electrostatic latent image formed on the surface of the photoconductor drum 21 is visualized.

As the developer, for example, a two-component developer can be used. The two-component developer includes a non-magnetic toner and a carrier. The carrier is, for example, iron powder having a particle size of several tens of microns (μm) or a polymer ferrite particle. The carrier is mixed with the toner in the developing machine 24 and imparts an electric charge (for example, a negative electric charge) to the toner by frictional electrification. The carrier conveys the toner to an electrostatic latent image portion by magnetic force.

The drum cleaning device (not illustrated) includes a cleaning blade and a toner containing unit. The cleaning blade comes into contact with the surface of the photoconductor drum 21 and removes residual toner. The residual toner is toner that remains on the surface of the photoconductor drum 21 after primary transfer. The removed residual toner is collected in the toner containing unit.

### Intermediate Transfer Unit 30

Next, the intermediate transfer unit 30 will be described. The intermediate transfer unit 30 includes an intermediate transfer body 31, a primary transfer roller 32, a plurality of support rollers 33 (33a to 33c), a secondary transfer roller 34, and a belt cleaning device 35, for example.

The intermediate transfer body 31 is, for example, an endless belt (transfer belt). For example, the intermediate transfer body 31 is a belt made of polyimide. The intermediate transfer body 31 may have electrical conductivity and elasticity, or may not have electrical conductivity and elasticity.

The support rollers 33a to 33c support the intermediate transfer body 31 such that tension is applied to the intermediate transfer body 31. Accordingly, the intermediate transfer body 31 is formed in a loop shape. Any one roller (for example, the support roller 33a) of the plurality of support rollers 33a to 33c is a drive roller. The rollers other than the drive roller are driven rollers. As the drive roller is driven rotationally, the intermediate transfer body 31 travels in a direction A in the drawing at a predetermined speed in a predetermined cycle.

A moving direction of the intermediate transfer body 31 can be defined as an upstream direction and a downstream direction. Specifically, the moving direction of the intermediate transfer body 31 can be defined by designating the image forming unit 20a as the most upstream direction and the belt cleaning device 35 as the most downstream direction.

The primary transfer roller 32 is disposed to face the photoconductor drum 21 with the intermediate transfer body 31 interposed therebetween. Specifically, the primary transfer roller 32 is disposed such that pressure is applied to the photoconductor drum 21 with the intermediate transfer body 31 interposed therebetween. Thus, the primary transfer roller 32 and the photoconductor drum 21 form a primary transfer portion that nips the intermediate transfer body 31.

When the intermediate transfer body 31 passes through the primary transfer portion, the toner image formed on the photoconductor drum 21 is transferred onto the passing portion. When the intermediate transfer body 31 passes through the primary transfer portion, a primary transfer bias is applied to the primary transfer roller 32. Specifically, a charge having a polarity (positive polarity) opposite to that of the toner is applied to the primary transfer roller 32. Thus, the toner image formed on the photoconductor drum 21 is electrostatically transferred onto the intermediate transfer body 31.

The secondary transfer roller 34 is disposed to face the support roller 33a with the intermediate transfer body 31 interposed therebetween. Specifically, the secondary transfer roller 34 is disposed such that the pressure is applied to the support roller 33a with the intermediate transfer body 31 interposed therebetween. Thus, the secondary transfer roller 34 and the support roller 33a form a secondary transfer portion 38 that nips the intermediate transfer body 31 and the sheet.

When the sheet passes through the secondary transfer portion 38, the toner image formed on the intermediate transfer body 31 is transferred onto the passing portion. When the sheet passes through the secondary transfer portion 38, a secondary transfer bias is applied to the support roller 33a. Specifically, a charge having the same polarity (negative polarity) as that of the toner is applied to the support roller 33a. Thus, the toner image on the intermediate transfer body 31 is electrostatically transferred to the sheet.

The secondary transfer roller 34 and the support roller 33a are configured to be separable from each other. Thus, when the sheet is jammed in the secondary transfer portion 38, the operator can remove the sheet.

The belt cleaning device 35 includes a cleaning blade and a toner containing unit. The cleaning blade comes into contact with the surface of the intermediate transfer body 31 and removes residual toner. Here, the residual toner refers to toner that remains on the surface of the intermediate transfer body 31 after secondary transfer. The residual toner removed by the cleaning blade is collected in the toner containing unit.

### Fixing Device 40

The fixing device 40 is an example of a fixing unit. The fixing device 40 heats and pressurizes the sheet to which the toner image (image) is transferred to fix the toner. The fixing device 40 includes, for example, an endless heating belt that heats the sheet and a pressure roller that is pressed against the heating belt. A heater is provided inside the heating belt. The heating belt is heated and a nip region is formed between the heating belt and the pressure roller, thereby melting the toner on the sheet and fixing to the sheet when the sheet passes through the nip region.

The fixing device 40 pressurizes the sheet with a predetermined load (applied pressure) when pressurizing the sheet. The fixing device 40 varies the load. For example, the fixing device 40 varies the load depending on the type of sheet. The fixing device 40 heats the sheet at a predetermined fixing temperature when pressurizing the sheet. The fixing device 40 varies the fixing temperature. For example, the fixing device 40 varies the fixing temperature depending on the type of sheet.

### Sheet Conveying Unit 50

Next, the sheet conveying unit 50 will be described. The sheet conveying unit 50 includes a pickup roller 51, a conveyance roller 52, a registration sensor 53a, a registration roller 53, a first guide portion 54a, a second guide portion 54b, and a paper discharge unit 55. A sheet contained in the sheet containing unit 140 is conveyed from the pickup roller 51 toward the paper discharge unit 55. Hereinafter, the pickup roller 51 side may be referred to as an “upstream side” and the paper discharge unit 55 side may be referred to as a “downstream side” in the sheet conveyance direction.

The pickup roller 51 picks up the sheets contained in the sheet containing unit 140 one by one, and conveys the picked-up sheet toward the downstream side in the sheet conveyance direction (toward the conveyance roller 52). The conveyance roller 52 conveys the sheet conveyed from the pickup roller 51 toward the downstream side (toward the registration roller 53).

The registration sensor 53a detects that the sheet conveyed from the conveyance roller 52 reaches the registration roller 53. The registration sensor 53a may be a contact sensor or a non-contact sensor (for example, an optical sensor).

The registration roller 53 (an example of a registration unit) adjusts a conveyance timing of the sheet when the sheet is conveyed to the secondary transfer portion 38. Specifically, the registration roller 53 stops the sheet conveyed from the conveyance roller 52 based on a detection result of the registration sensor 53a, and conveys the sheet toward the secondary transfer portion 38 at a predetermined timing. The predetermined timing is a timing at which the toner image formed on the intermediate transfer body 31 is secondarily transferred by the secondary transfer portion 38.

The registration roller 53 forms a nip. The registration roller 53 adjusts a leading end of the sheet conveyed from the conveyance roller 52 at the nip, and then conveys the sheet toward the downstream side. The image forming apparatus 100 performs aligning of the sheet. The aligning is a process in which the leading end of the sheet abuts against the registration roller 53 to adjust the orientation of the sheet. In other words, the registration roller 53 is a portion that aligns the sheet by the leading end of the conveyed sheet abutting thereto.

The first guide portion 54a restricts the conveyance direction of the sheet conveyed from the registration roller 53 to the secondary transfer portion 38. The secondary transfer portion 38 transfers the toner image to the sheet whose conveyance direction is restricted by the first guide portion 54a. The sheet to which the toner image is transferred is conveyed toward the second guide portion 54b and the fixing device 40 by the secondary transfer portion 38.

The second guide portion 54b restricts the conveyance direction of the sheet conveyed from the secondary transfer portion 38 and conveys the sheet to the fixing device 40. The fixing device 40 heats and pressurizes the sheet whose conveyance direction is restricted by the second guide portion 54b and conveys the sheet to the paper discharge unit 55. The paper discharge unit 55 conveys the sheet to a discharge tray.

### Wireless Tag Communication Device 60

The wireless tag communication device 60 includes a communication control circuit (control unit) and an antenna that are not illustrated. The wireless tag in the present embodiment is, for example, an RFID tag. For example, the wireless tag communication device 60 transmits a radio wave in a direction of an arrow K in the drawing. The wireless tag communication device 60 communicates with a wireless tag provided in the wireless tag sheet via the antenna. Specifically, the wireless tag communication device 60 performs a writing process (write function) of writing information to the wireless tag and a reading process (read function) of reading the information written in the wireless tag.

The writing process is a process of writing information to the wireless tag of the wireless tag sheet picked up from the sheet containing unit 140. The reading process is a process of reading information from the wireless tag to confirm that information is written in the wireless tag. The wireless tag communication device 60 performs the writing process and the reading process when the wireless tag sheet passes a predetermined position on the conveyance path (on the sheet conveying unit 50). The predetermined position is, for example, a section from a position where the wireless tag sheet is picked up by the pickup roller 51 to a position where the sheet reaches the secondary transfer portion (the secondary transfer roller 34).

In a wireless tag sheet used in logistics or the like, information to be written to the wireless tag includes information indicating contents, information indicating a destination, and contents to be printed on the sheet, for example. For example, a radio wave method in a 900 MHZ bandwidth (UHF) is used for communication in the wireless tag communication device 60. A frequency bandwidth is not limited thereto, and other frequency bandwidths can be adopted. A wireless tag method is not limited to the RFID method, and other methods can be adopted.

The wireless tag communication device 60 is not limited to being disposed at a position illustrated in the drawing. For example, the wireless tag communication device 60 may be disposed closer to the paper feed unit (the sheet containing unit 140) or closer to the paper discharge unit 55 compared to the position illustrated in the drawing. A communication range may also be set to a range according to the position of the wireless tag communication device 60.

### About Damage to Wireless Tag

Here, when the wireless tag sheet passes through the fixing device 40, the wireless tag provided in the wireless tag sheet may be damaged due to pressure in the nip region. Therefore, the present embodiment is configured to prevent such damage to the wireless tag. A functional configuration of the image forming apparatus 100 according to the present embodiment will be described below.

### Functional Configuration of Image Forming Apparatus 100

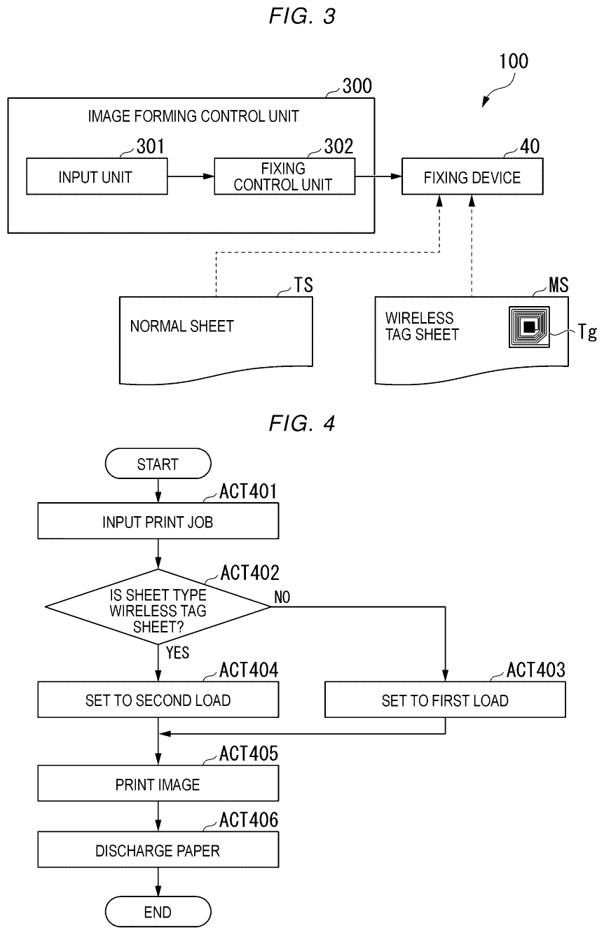

FIG. 3 is a block diagram illustrating an example of a functional configuration of the image forming apparatus 100 according to the present embodiment. In FIG. 3, the image forming apparatus 100 includes an image forming control unit 300 and a fixing device 40. The image forming control unit 300 includes an input unit 301 and a fixing control unit 302. The image forming control unit 300 (the input unit 301 and the fixing control unit 302) controls the fixing device 40 according to a fixing control program stored in a storage device (not illustrated).

The image forming control unit 300 is implemented by, for example, a central processing unit (CPU) or an application specific integrated circuit (ASIC). A storage device (not illustrated) is implemented by a read only memory (ROM), a random access memory (RAM), a hard disk drive (HDD), a solid state drive (SSD), or the like.

### Input Unit 301

The input unit 301 inputs a print job (print instruction). The print job includes various types of information. The various types of information include a sheet type, a type of printing (grayscale or color), the number of copies, whether double-sided printing is to be performed, enlargement or reduction, a finishing mode (whether stapling is to be performed), and the like. The sheet type includes a wireless tag sheet MS and a normal sheet TS. The print job is set by operation input from the display 110 or the control panel 120. When the image forming apparatus 100 is connected to an external device such as a personal computer, the print job is set in the external device. The input unit 301 inputs the print job output from the display 110, the control panel 120, or the external device.

### Normal Sheet TS and Wireless Tag Sheet MS

The normal sheet TS is an example of a first sheet. The normal sheet TS does not include a wireless tag Tg. For example, the normal sheet TS is a normal copy paper.

The wireless tag sheet MS is an example of a second sheet. The wireless tag sheet MS includes the wireless tag Tg. The wireless tag Tg is provided at a leading end of the wireless tag sheet MS. The leading end of the wireless tag sheet MS is a region at a leading part in the sheet conveyance direction. The position of the wireless tag Tg is not limited to the leading end of the wireless tag sheet MS, and may be a tailing end of the wireless tag sheet MS or at outer peripheries (regions on both sides) excluding the leading end and the tailing end.

Each of the normal sheet TS and the wireless tag sheet MS is conveyed to the fixing device 40, and a toner image formed on the surface of each of the sheets is fixed thereto.

### Fixing Control Unit 302

The fixing control unit 302 controls the fixing device 40. When pressure is applied to the wireless tag sheet MS, the fixing control unit 302 controls a load (applied pressure) to be lower than that of the normal sheet TS. Specifically, the fixing control unit 302 performs first control and second control. The first control is control to pressurize the normal sheet TS with a first load. The second control is control to pressurize the wireless tag sheet MS with a second load. Hereinafter, the first load may be referred to as a “normal load”, and the second load may be referred to as a “low load”.

### Control Timing

A timing at which the first control and the second control are performed is a timing at which the sheet is conveyed to the registration roller 53. In other words, the fixing control unit 302 performs the first control or the second control when the sheet is detected by the registration sensor 53a.

### Fixing Control Process Performed by Image Forming Apparatus 100 According to Embodiment

Next, an example of a fixing control process performed by the image forming apparatus 100 (the fixing control unit 302) will be described with reference to FIG. 4.

FIG. 4 is a flowchart illustrating an example of the fixing control process performed by the image forming apparatus 100 according to the present embodiment. In FIG. 4, the image forming apparatus 100 inputs a print job from the control panel 120 or the external device (ACT 401). Then, the image forming apparatus 100 determines whether information indicating a sheet type included in the print job indicates the wireless tag sheet MS (ACT 402).

When the information indicating the sheet type does not indicate the wireless tag sheet MS (ACT 402: NO), that is, when the information indicating the sheet type indicates the normal sheet TS, the image forming apparatus 100 sets a load of the fixing device 40 to the first load (normal load) as the first control (ACT 403), and the process proceeds to ACT 405.

Meanwhile, when the information indicating the sheet type indicates the wireless tag sheet MS (ACT 402: YES), the image forming apparatus 100 sets a load of the fixing device 40 to the second load (low load) as the second control (ACT 404). Then, the image forming apparatus 100 prints an image with the set load (ACT 405). After the printing is completed, the image forming apparatus 100 discharges the sheet onto the discharge tray (ACT 406), and a series of processes ends.

As described above, the image forming apparatus 100 according to the present embodiment performs, on the fixing device 40, the first control to pressurize the normal sheet TS with the normal load and the second control to pressurize the wireless tag sheet MS with the low load. Thus, it is possible to reduce pressure caused by the load of the fixing device 40 when printing on the wireless tag sheet MS. Therefore, it is possible to prevent the wireless tag Tg from being damaged by the load of the fixing device 40.

If the fixing device 40 is controlled in response to regions on the sheet (in region units) depending on presence of the wireless tag Tg, the control may become complicated. Image unevenness may also occur. In contrast, the image forming apparatus 100 according to the present embodiment controls the fixing device 40 in sheet units. Therefore, control can be simplified, and image unevenness can also be prevented.

The image forming apparatus 100 performs the first control or the second control at a timing when the sheet is conveyed to the registration roller 53. Thus, the first control or the second control can be performed at an optimal timing for each conveyed sheet.

### Modifications

Next, modifications of the embodiment will be described. In each of following modifications, the contents already described in the above embodiment will not be described as appropriate. Each of the following modifications can be combined with the embodiment described above.

First Modification: Second Control when Printing Ratio is Equal to or Lower than Predetermined Value

In a first modification, second control based on an image density of the wireless tag sheet MS will be described. The image density is a ratio of a printed area to a sheet area. The fixing control unit 302 performs the second control based on the image density to be printed on the wireless tag sheet MS.

In the first modification, the image density is, for example, a printing ratio. The printing ratio is a ratio of a total area of characters to be printed to the sheet area. The higher the printing ratio, the greater the amount of characters to be printed. In other words, the higher the printing ratio, the higher the image density. The fixing control unit 302 acquires the printing ratio from the input image processing unit 10, for example.

When the printing ratio is low, even when the load of the fixing device 40 is lower than normal, a decrease in image quality (fixing efficiency) is unlikely to occur. Therefore, when the printing ratio of the wireless tag sheet MS is equal to or lower than a predetermined value, that is, when the printing ratio is low, the fixing control unit 302 sets the load of the fixing device 40 to a low load as the second control. The predetermined value is a value set in advance. The setting of the predetermined value may be changeable.

Meanwhile, when the printing ratio is high, a decrease in image quality (fixing efficiency) may occur when the load of the fixing device 40 is lower than normal. Therefore, the fixing control unit 302 sets the load of the fixing device 40 to a normal load as the first control when the printing ratio of the wireless tag sheet MS exceeds the predetermined value.

### Fixing Control Process Performed by Image Forming Apparatus 100 According to First Modification

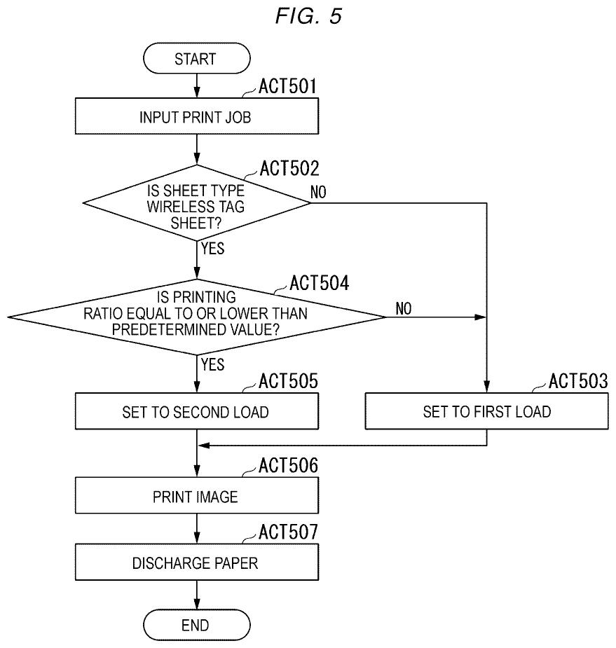

Next, an example of a fixing control process performed by the image forming apparatus 100 (the fixing control unit 302) according to the first modification will be described with reference to FIG. 5.

FIG. 5 is a flowchart illustrating an example of the fixing control process performed by the image forming apparatus 100 according to the first modification. In FIG. 5, the image forming apparatus 100 inputs a print job from the control panel 120 or the external device (ACT 501). Then, the image forming apparatus 100 determines whether information indicating a sheet type included in the print job indicates the wireless tag sheet MS (ACT 502).

When the information indicating the sheet type does not indicate the wireless tag sheet MS (ACT 502: NO), that is, when the information indicating the sheet type indicates the normal sheet TS, the image forming apparatus 100 sets the load of the fixing device 40 to the first load as the first control (ACT 503), and the process proceeds to ACT 506.

Meanwhile, when the information indicating the sheet type indicates the wireless tag sheet MS (ACT 502: YES), the image forming apparatus 100 determines whether the printing ratio is equal to or lower than the predetermined value (ACT 504). When the printing ratio is not equal to or lower than the predetermined value (ACT 504: NO), that is, when the printing ratio is high, the process proceeds to ACT 503 and the load of the fixing device 40 is set to the first load (normal load) as the first control.

Meanwhile, when the printing ratio is equal to or lower than the predetermined value (ACT 504: YES), that is, when the printing ratio is low, the image forming apparatus 100 sets the load of the fixing device 40 to the second load (low load) as the second control (ACT 505). Then, the image forming apparatus 100 prints an image with the set load (ACT 506). After the printing is completed, the image forming apparatus 100 discharges the sheet onto the discharge tray (ACT 507), and a series of processes ends.

As described above, the image forming apparatus 100 according to the first modification performs the second control (low load) when the printing ratio of the wireless tag sheet MS is equal to or lower than the predetermined value. Accordingly, when the printing ratio of the wireless tag sheet MS is low, it is possible to prevent a decrease in image quality while reducing pressure caused by the load of the fixing device 40. Therefore, it is possible to prevent the wireless tag Tg from being damaged by the load of the fixing device 40.

The image forming apparatus 100 according to the first modification performs the first control when the printing ratio of the wireless tag sheet MS exceeds the predetermined value. In other words, when the printing ratio of the wireless tag sheet MS is high, the load of the fixing device 40 is set to the normal load. Therefore, it is possible to prevent a decrease in image quality when the printing ratio is high.

Second Modification: Second Control when Amount of Secondary Color is Equal to or Lower than Predetermined Value

Next, a second modification will be described. In the first modification described above, an example in which the image density is the printing ratio was described. In the second modification, an example will be described in which the image density is an amount of secondary color instead of or in addition to such configuration.

The secondary color is a color generated by a combination of colors (YMCK). The greater the amount of secondary color, the greater the amount of toner to be used, that is, the higher the image density. The fixing control unit 302 acquires the amount of secondary color from the input image processing unit 10, for example.

When the amount of secondary color is small, even when the load of the fixing device 40 is lower than normal, a decrease in image quality (fixing efficiency) is unlikely to occur. Therefore, when the amount of secondary color to be printed on the wireless tag sheet MS is equal to or lower than a predetermined value, the fixing control unit 302 sets the load of the fixing device 40 to a low load as the second control. Thus, when the amount of secondary color to be printed on the wireless tag sheet MS is small, it is possible to prevent a decrease in image quality while reducing pressure caused by the load of the fixing device 40. The predetermined value is a value set in advance. The setting of the predetermined value may be changeable.

When the amount of secondary color to be printed on the wireless tag sheet MS exceeds the predetermined value, the fixing control unit 302 sets the load of the fixing device 40 to the normal load as the first control. Therefore, it is possible to prevent a decrease in image quality when the amount of secondary color is large.

### Third Modification: Control During Double-Sided Printing

Next, a third modification will be described. In the embodiment described above, an example of single-sided printing on the wireless tag sheet MS was described. In the third modification, an example of double-sided printing on the wireless tag sheet MS will be described. In the third modification, an example in which a fixing temperature of the fixing device 40 is also controlled will be described.

### Load Control According to Printed Side

In the third modification, during double-sided printing on the wireless tag sheet MS, the fixing control unit 302 performs the first control (normal load) when one side is printed, and performs the second control (low load) when the other side is printed. The one side is, for example, a first side on which first printing is performed. The other side is a second side on which second printing is performed.

### Control of Fixing Temperature

A fixing efficiency of the fixing device 40 depends on the load and the fixing temperature in the nip region. Therefore, in the third modification, the fixing control unit 302 performs temperature control of setting a fixing temperature in the first control (normal load) (first temperature) and a fixing temperature in the second control (low load) (second temperature) to be different from each other. Specifically, the fixing control unit 302 controls the fixing temperature in the second control to be higher than the fixing temperature in the first control.

### Temperature Control According to Printed Side

In particular, in double-sided printing, the heat of the fixing device 40 may be taken away by the sheet due to printing (fixing) on the first side. Accordingly, there is a risk that the fixing temperature of the fixing device 40 decreases during printing on the second side. In the third modification, therefore, during double-sided printing on the wireless tag sheet MS, the fixing control unit 302 controls the fixing temperature during printing on the second side to a temperature higher than the fixing temperature during printing on the first side. Therefore, in the third modification, the first control is referred to as control of “normal load and normal temperature”, and the second control is referred to as control of “low load and high temperature”.

### Fixing Control Process Performed by Image Forming Apparatus 100 According to Third Modification

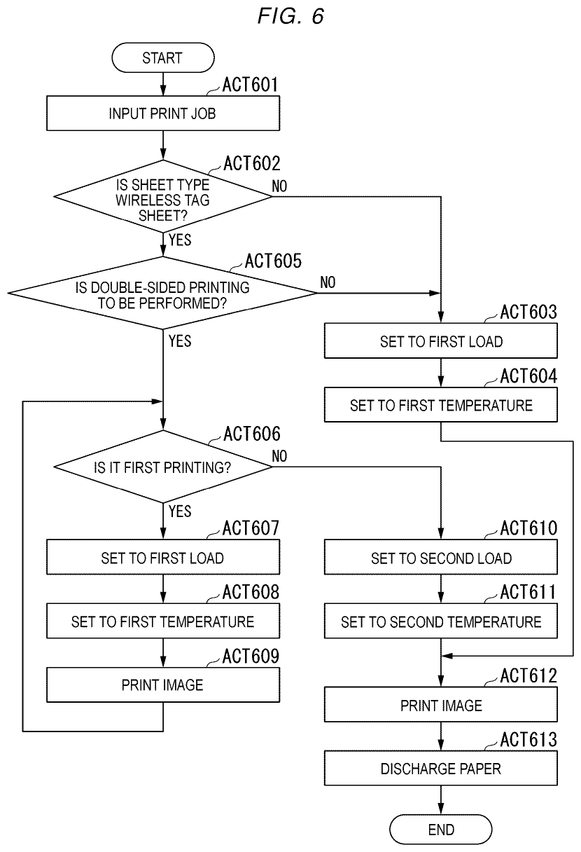

Next, an example of a fixing control process performed by the image forming apparatus 100 (the fixing control unit 302) according to the third modification will be described with reference to FIG. 6.

FIG. 6 is a flowchart illustrating an example of the fixing control process performed by the image forming apparatus 100 according to the third modification. In FIG. 6, the image forming apparatus 100 inputs a print job from the control panel 120 or the external device (ACT 601). Then, the image forming apparatus 100 determines whether information indicating a sheet type included in the print job indicates the wireless tag sheet MS (ACT 602).

When the information indicating the sheet type does not indicate the wireless tag sheet MS (ACT 602: NO), that is, when the information indicating the sheet type indicates the normal sheet TS, the image forming apparatus 100 sets the load of the fixing device 40 to the first load (normal load) as the first control (ACT 603). The image forming apparatus 100 sets the fixing temperature of the fixing device 40 to the first temperature (normal temperature) as the first control (ACT 604), and the process proceeds to ACT 612 to perform single-sided printing.

Meanwhile, when the information indicating the sheet type indicates the wireless tag sheet MS (ACT 602: YES), the image forming apparatus 100 determines whether double-sided printing is to be performed (ACT 605). When double-sided printing is not to be performed (ACT 605: NO), that is, when single-sided printing is to be performed on the wireless tag sheet MS, the process proceeds to ACT 503, and the image forming apparatus 100 performs the first control (ACT 603 and ACT 604).

Meanwhile, when it is determined in ACT 605 that double-sided printing is to be performed (ACT 605: YES), the image forming apparatus 100 determines whether it is first printing (ACT 606). When it is the first printing (ACT 606: YES), the image forming apparatus 100 sets the load of the fixing device 40 to the first load (normal load) as the first control (ACT 607). The image forming apparatus 100 sets the fixing temperature of the fixing device 40 to the first temperature (normal temperature) as the first control (ACT 608). Then, the image forming apparatus 100 prints an image on the first side (ACT 609), and the process returns to ACT 606.

Meanwhile, when it is determined in ACT 606 that it is not first printing (ACT 606: NO), that is, when it is second printing, the image forming apparatus 100 sets the load of the fixing device 40 to the second load (low load) as the second control (ACT 610). The image forming apparatus 100 sets the fixing temperature of the fixing device 40 to the second temperature (high temperature) as the second control (ACT 611). Then, the image forming apparatus 100 prints an image on the second side (ACT 612). After the printing is completed, the image forming apparatus 100 discharges the sheet onto the discharge tray (ACT 613), and a series of processes ends.

As described above, during double-sided printing on the wireless tag sheet MS, the image forming apparatus 100 according to the third modification performs the first control when one side is printed and performs the second control when the other side is printed. Thus, during double-sided printing on the wireless tag sheet MS, it is possible to reduce pressure caused by the load of the fixing device 40 when the one side is printed. In other words, it is possible to prevent high pressure caused by the normal load from being applied during double-sided printing. Therefore, it is possible to prevent the wireless tag Tg from being damaged by the load of the fixing device 40.

The image forming apparatus 100 according to the third modification controls the fixing temperature in the first control to be different from the fixing temperature in the second control during double-sided printing on the wireless tag sheet MS. Thus, it is possible to set an optimal fixing temperature according to the load of the fixing device 40, thereby preventing a decrease in image quality.

During double-sided printing on the wireless tag sheet MS, the image forming apparatus 100 according to the third modification performs the first control in which the fixing temperature is set to the normal temperature when the first side is printed and performs the second control in which the fixing temperature is set to a temperature higher than the normal temperature when the second side is printed. Thus, even when the heat of the fixing device 40 is taken away by the sheet due to printing (fixing) on the first side, a decrease in image quality of the second side can be prevented.

In the third modification, the second control is control of “low load and high temperature”, but the second control is not limited thereto. The second control may be control of “low load and normal temperature” as in the embodiment. In other words, it is also possible not to perform temperature control in the second control according to the third modification.

### Fourth Modification: Second Control During Printing on First Side in Double-Sided Printing

Next, a fourth modification will be described. In the third modification described above, an example in which the first control is performed during the printing on the first side and the second control is performed during the printing on the second side was described. Here, in double-sided printing, as the sheet is heated by the printing (fixing) on the first side, an increase in the fixing temperature during the printing on the second side may not be necessary.

In the fourth modification, therefore, the second control is performed during the printing on the first side, and the first control is performed during the printing on the second side. In other words, the fixing control unit 302 according to the fourth modification performs control of “low load and high temperature” as the second control during the printing on the first side, and performs control of “normal load and normal temperature” as the first control during the printing on the second side.

According to the fourth modification, it is possible to reduce the load of the fixing device 40 during the printing on the first side in double-sided printing on the wireless tag sheet MS. In other words, it is possible to prevent high pressure caused by the normal load from being applied in double-sided printing. Therefore, it is possible to prevent the wireless tag Tg from being damaged by the load of the fixing device 40. According to the fourth modification, a decrease in image quality of the first side can be prevented, and the sheet is heated by the printing (fixing) on the first side. Therefore, the fixing temperature during the printing on the second side can be set to an optimal temperature, and thus a decrease in image quality can be prevented.

### Fifth Modification: Second Control During Single-Sided Printing

Next, a fifth modification will be described. In the third modification described above, an example in which the first control (normal load and normal temperature) is performed during single-sided printing on the wireless tag sheet MS (ACTs 602 to 605 in FIG. 6) was described. In the fifth modification, an example in which the second control (low load and high temperature) is performed during single-sided printing on the wireless tag sheet MS in the image forming apparatus 100 according to the third modification will be described.

When it is determined in ACT 605 of FIG. 6 that double-sided printing is not to be performed (ACT 605: NO), that is, determined that single-sided printing is to be performed on the wireless tag sheet MS, the process proceeds to ACT 610, and the image forming apparatus 100 according to the fifth modification performs the second control (low load and high temperature).

Thus, it is possible to reduce pressure caused by the load of the fixing device 40 during single-sided printing on the wireless tag sheet MS. Since the fixing temperature is set to the second temperature (high temperature), it is possible to prevent a decrease in image quality during single-sided printing on the wireless tag sheet MS.

### Second Control According to Printing Ratio During Single-Sided Printing

In the fifth modification, during single-sided printing on the wireless tag sheet MS, the second control (low load and high temperature) may be performed when the printing ratio is equal to or lower than a predetermined value. In other words, during single-sided printing on the wireless tag sheet MS, when the printing ratio exceeds the predetermined value, the fixing control unit 302 may perform the first control (normal load and normal temperature).

### Sixth Modification: Second Control for Both of First Side and Second Side in Double-Sided Printing

In the third and fourth modifications described above, an example in which the second control is performed on one side in double-sided printing was described. In the sixth modification, an example in which the second control is performed on the first side and the second side in double-sided printing will be described. In other words, in the sixth modification, the fixing control unit 302 performs control of “low load and high temperature” on the first side and the second side.

Thus, it is possible to reduce pressure caused by the load of the fixing device 40 during the printing on each of the first side and the second side in double-sided printing on the wireless tag sheet MS. Accordingly, it is possible to more effectively prevent the wireless tag Tg from being damaged by the load of the fixing device 40. The image quality can be improved on both of the first side and the second side.

Seventh Modification: Example in which Conveyance Speed is Set to Low Speed in Second Control

In the third modification described above, an example in which the fixing temperature is set to a high temperature in the second control was described. Instead of or in addition to such configuration, an example in which the conveyance speed of the wireless tag sheet MS is set to a low speed in the second control in a seventh modification will be described.

In the seventh modification, the image forming control unit 300 includes a conveyance control unit. The conveyance control unit controls the sheet conveying unit 50 to set the conveyance speed in the second control to a speed lower than the conveyance speed in the first control. Thus, it is possible to lengthen a passing time when the wireless tag sheet MS passes through the fixing device 40 (fixing time). In other words, when the conveyance speed is set to a low speed, it is possible to obtain the same effect as when the fixing temperature is set to a high temperature. Therefore, it is possible to prevent a decrease in image quality.

### Eighth Modification: Example of Widening Conveyance Interval of Sheet in Second Control

In the third modification described above, an example in which the fixing temperature is set to a high temperature in the second control was described. Instead of or in addition to such configuration, an example in which a conveyance interval of the sheet is widened in the second control in an eighth modification will be described.

In the eighth modification, the image forming control unit 300 includes a conveyance control unit. The conveyance control unit controls the sheet conveying unit 50 to widen the conveyance interval of the sheet in the second control compared to the conveyance interval of the sheet in the first control. Accordingly, the wireless tag sheet MS can enter the fixing device 40 with an interval. Therefore, it is possible to reduce a degree of decrease in the fixing temperature caused by the sheet passing through the fixing device 40. In other words, when the conveyance interval is widened, it is possible to obtain the same effect as when the fixing temperature is set to a high temperature. Therefore, it is possible to prevent a decrease in image quality.

### Ninth Modification: Control Low Load or Fixing Temperature in Multiple Stages in Second Control

In the embodiment described above, an example in which the load is set in a single stage in the second control was described. In a ninth modification, an example in which the load (or fixing temperature) in the second control can be set in multiple stages (for example, two stages) will be described. The multiple stages are not limited to two stages, and may also be set to three or more stages.

In the ninth modification, control of the low load in the second control is divided into two stages of a first low load (weakly low load) and a second low load (extremely low load) weaker than the first low load. The fixing control unit 302 sets either the first low load or the second low load according to the temperature of the fixing device, for example. Specifically, the fixing control unit 302 may set the second low load (extremely low load) when the temperature of the fixing device 40 is a normal temperature (exceeds a predetermined temperature), and may set the first low load (weakly low load) when the temperature of the fixing device 40 is low (is equal to or lower than a predetermined temperature). Thus, since the “low load” in the second control can be set to a load corresponding to the fixing temperature, the wireless tag Tg can be prevented from being damaged, and the image quality can be maintained. The fixing control unit 302 may set the first load (weakly low load) when a sheet thickness of the wireless tag sheet MS is equal to or greater than a predetermined value, and may set the second low load (extremely low load) when the sheet thickness is less than the predetermined value. Thus, since the “low load” in the second control can be set to a load corresponding to the sheet thickness, the wireless tag Tg can be prevented from being damaged, and the image quality can be maintained.

In the ninth modification described above, the fixing temperature in the second control may be set in multiple stages (for example, two stages). Specifically, the high temperature control in the second control can be divided into a first high temperature (weakly high temperature) and a second high temperature (strongly high temperature) higher than the first high temperature. For example, the fixing control unit 302 may set the second high temperature (strongly high temperature) when the sheet thickness of the wireless tag sheet MS is equal to or greater than a predetermined value, and may set the first high temperature (weakly high temperature) when the sheet thickness is less than the predetermined value. Thus, since the “high temperature” in the second control can be set to a temperature corresponding to the sheet thickness, the wireless tag Tg can be prevented from being damaged, and the image quality can be maintained.

A part of the functions of the image forming apparatus 100 in the embodiment described above may be implemented by a computer. Then, programs for implementing the functions are recorded in a computer-readable recording medium. A computer system may read and execute the programs recorded in the recording medium, thereby implementing the functions.

The functions of the image forming apparatus 100 in the embodiment described above may be implemented by a computer. Then, programs for implementing the functions may be recorded on a computer-readable recording medium and the programs may be read and executed by a computer or a computer system, thereby implementing the functions. Here, the “computer system” includes an OS and hardware such as a peripheral device. The “computer-readable recording medium” includes a portable medium such as a universal serial bus (USB) flash memory, a solid state drive (SSD), a flexible disk, a magneto-optical disk, a ROM, or a CD-ROM, or a storage device such as a hard disk built in a computer system. The “computer-readable recording medium” may also include a medium that dynamically stores the programs for a short period of time, such as a communication line used when transmitting the programs via a network such as the Internet or via a communication link such as a telephone line, and a medium that stores the programs for a fixed period of time, such as a volatile memory in a computer system functioning as a server or a client when dynamically storing the programs for a short period of time. The program described above may be a program for implementing a part of the functions described above and may be a program that can realize the functions described above in combination with a program recorded in advance in the computer system.

Supplementary Notes according to the present embodiment will be described below.

### Supplementary Note 1

An image forming apparatus including:
a fixing unit configured to pressurize a sheet to fix an image onto the sheet; and
a fixing control unit configured to perform, on the fixing unit, a first control for pressurizing a first sheet not including a wireless tag with a first load and a second control for pressurizing a second sheet including the wireless tag with a second load lower than the first load.

### Supplementary Note 2

The apparatus according to Supplementary Note 1, in which
when an image density of the second sheet is equal to or lower than a predetermined value, the fixing control unit performs the second control.

### Supplementary Note 3

The apparatus according to Supplementary Note 1, in which
in double-sided printing on the second sheet, the fixing control unit performs the first control when one side is printed and performs the second control when another side is printed.

### Supplementary Note 4

The apparatus according to Supplementary Note 3, in which
in double-sided printing on the second sheet, the fixing control unit performs the first control on a first side to be printed earlier and performs the second control on a second side to be printed later.

### Supplementary Note 5

The apparatus according to any one of Supplementary Notes 1 to 4, in which
when the sheet is pressurized, the fixing unit pressurizes the sheet at a predetermined fixing temperature, and
the fixing control unit controls a fixing temperature in the second control to a temperature higher than a fixing temperature in the first control.

### Supplementary Note 6

The apparatus according to Supplementary Note 2, in which, when the image density of the second sheet exceeds the predetermined value, the fixing control unit performs the first control.

### Supplementary Note 7

The apparatus according to any one of Supplementary Notes 1 to 3, in which the fixing control unit performs the first control or the second control at a timing when the sheet is conveyed to a registration unit disposed upstream of the fixing unit in a sheet conveyance direction.

### Supplementary Note 8

The apparatus according to any one of Supplementary Notes 1 to 3, further including a conveyance control unit configured to control a conveyance speed of the sheet, in which
the conveyance control unit controls the conveyance speed in the second control to be slower than the conveyance speed in the first control.

### Supplementary Note 9

The apparatus according to any one of Supplementary Notes 1 to 3, in which, in double-sided printing on the second sheet, the fixing control unit performs the second control in printing of each of one side and the other side.

### Supplementary Note 10

A program that causes a computer of an image forming apparatus that includes a fixing unit configured to pressurize a sheet to fix an image onto the sheet to function as: a fixing control unit configured to perform, on the fixing unit, a first control for pressurizing a first sheet not including a wireless tag with a first load and a second control for pressurizing a second sheet including the wireless tag with a second load lower than the first load.

### Supplementary Note 11

An image forming method in which an image forming apparatus including a fixing unit configured to pressurize a sheet to fix an image onto the sheet executes a process including:
fixing control of performing, on the fixing unit, a first control for pressurizing a first sheet not including a wireless tag with a first load and a second control for pressurizing a second sheet including the wireless tag with a second load lower than the first load.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a fixing component configured to pressurize a sheet to fix an image onto the sheet; and
a fixing controller configured to perform, on the fixing component, a first control for pressurizing a first sheet not including a wireless tag with a first load and a second control for pressurizing a second sheet including the wireless tag with a second load lower than the first load.

2. The image forming apparatus according to claim 1, wherein
when an image density of the second sheet is equal to or lower than a predetermined value, the fixing controller performs the second control.

3. The image forming apparatus according to claim 1, wherein
in double-sided printing on the second sheet, the fixing controller performs the first control when a first side is printed and performs the second control when a second side is printed.

4. The image forming apparatus according to claim 3, wherein
in double-sided printing on the second sheet, the fixing controller performs the first control on a first side to be printed earlier and performs the second control on a second side to be printed later.

5. The image forming apparatus according to claim 1, wherein
when the sheet is pressurized, the fixing component pressurizes the sheet at a predetermined fixing temperature, and
the fixing controller controls a fixing temperature in the second control to a temperature higher than a fixing temperature in the first control.

6. The image forming apparatus according to claim 1, wherein
the fixing component comprises an endless heating belt that heats the sheet and a pressure roller configured to be pressed against the endless heating belt.

7. The image forming apparatus according to claim 1, wherein
in the second control when a printing ratio of the second sheet is equal to or lower than a predetermined value, pressure is reduced.

8. The image forming apparatus according to claim 1, wherein
in the first control when a printing ratio of the second sheet exceeds a predetermined value, the second load of the fixing component is increased.

9. An image forming method executed by an image forming apparatus including a fixing component configured to pressurize a sheet to fix an image onto the sheet, the method comprising:
performing, on the fixing component, a first control for pressurizing a first sheet not including a wireless tag with a first load and a second control for pressurizing a second sheet including the wireless tag with a second load lower than the first load.

10. The image forming method according to claim 9, further comprising:
when an image density of the second sheet is equal to or lower than a predetermined value, performing the second control.

11. The image forming method according to claim 9, further comprising:
in double-sided printing on the second sheet, performing the first control when a first side is printed and performing the second control when a second side is printed.

12. The image forming method according to claim 11, further comprising:
in double-sided printing on the second sheet, performing the first control on a first side to be printed earlier and performing the second control on a second side to be printed later.

13. The image forming method according to claim 9, further comprising:
when the sheet is pressurized, pressurizing the sheet at a predetermined fixing temperature, and
controlling a fixing temperature in the second control to a temperature higher than a fixing temperature in the first control.

14. The image forming method according to claim 9, further comprising:
in the second control when a printing ratio of the second sheet is equal to or lower than a predetermined value, reducing pressure.

15. The image forming method according to claim 9, further comprising:
in the first control when a printing ratio of the second sheet exceeds a predetermined value, increasing the second load of the fixing component.

16. A multifunction peripheral, comprising:
an image processing component;
an image forming component;
a fixing component configured to pressurize a sheet to fix an image onto the sheet; and
a fixing controller configured to perform, on the fixing component, a first control for pressurizing a first sheet not including a wireless tag with a first load and a second control for pressurizing a second sheet including the wireless tag with a second load lower than the first load.

17. The multifunction peripheral according to claim 16, wherein
when an image density of the second sheet is equal to or lower than a predetermined value, the fixing controller performs the second control.

18. The multifunction peripheral according to claim 16, wherein
in double-sided printing on the second sheet, the fixing controller performs the first control when a first side is printed and performs the second control when a second side is printed.

19. The multifunction peripheral according to claim 18, wherein
in double-sided printing on the second sheet, the fixing controller performs the first control on a first side to be printed earlier and performs the second control on a second side to be printed later.

20. The multifunction peripheral according to claim 16, wherein
when the sheet is pressurized, the fixing component pressurizes the sheet at a predetermined fixing temperature, and
the fixing controller controls a fixing temperature in the second control to a temperature higher than a fixing temperature in the first control.
